(19) United States
(12) Patent Application Publication
(10) Pub. No.: US 2010/0034416 A1
(43) Pub. Date: Feb. 11, 2010

(54) RECEIVING STRUCTURE FOR SPEAKER

(75) Inventors: CHIH-CHIANG CHANG, Shindian (TW); ZHI LI, Shenzhen City (CN); ZHI-YUN SHEN, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (Hong Kong) Limited, Kowloon (HK)

(21) Appl. No.: 12/503,919

(22) Filed: Jul. 16, 2009

(30) Foreign Application Priority Data
Aug. 8, 2008 (CN) 200810303621.1

(51) Int. Cl. H04R 1/02

(52) U.S. Cl. 381/386

(57) ABSTRACT

A receiving structure for a speaker includes a housing having a receiving cavity defining a sound slot at the bottom thereof, a filter defining a sound aperture without through out the filter, and an engaging board fixed with a speaker; the filter is received in the receiving cavity and the sound slot is shielded by filter, the sound aperture aligns with the sound slot, the engaging board engages the housing and covers the receiving cavity, and the speaker aligns with the sound aperture.

### BACKGROUND

1. Technical Field

The present invention generally relates to speaker structure and, more particularly, to a receiving structure for a speaker in an electronic device.

2. Description of Related Art

Electronic devices such as mobile phones and notebooks often have a speaker assembled therein, requiring a receiving structure for the speaker inside the electronic device. A typical receiving structure includes a housing defining a cavity. The bottom of the cavity includes a plurality of small apertures through which sound from the speaker is emitted. However, the apertures are not shielded from the outside, and contaminants can enter the electronic device therethrough and generally deteriorate sound quality of the speaker.

Therefore, there is room for improvement within the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is exploded view of an exemplary embodiment of a receiving structure for a speaker.

FIG. 2 is an assembled, isometric view of the receiving structure of FIG. 1.

FIG. 3 is an isometric view from another angle shown in FIG. 2.

### DETAILED DESCRIPTION OF THE EMBODIMENT

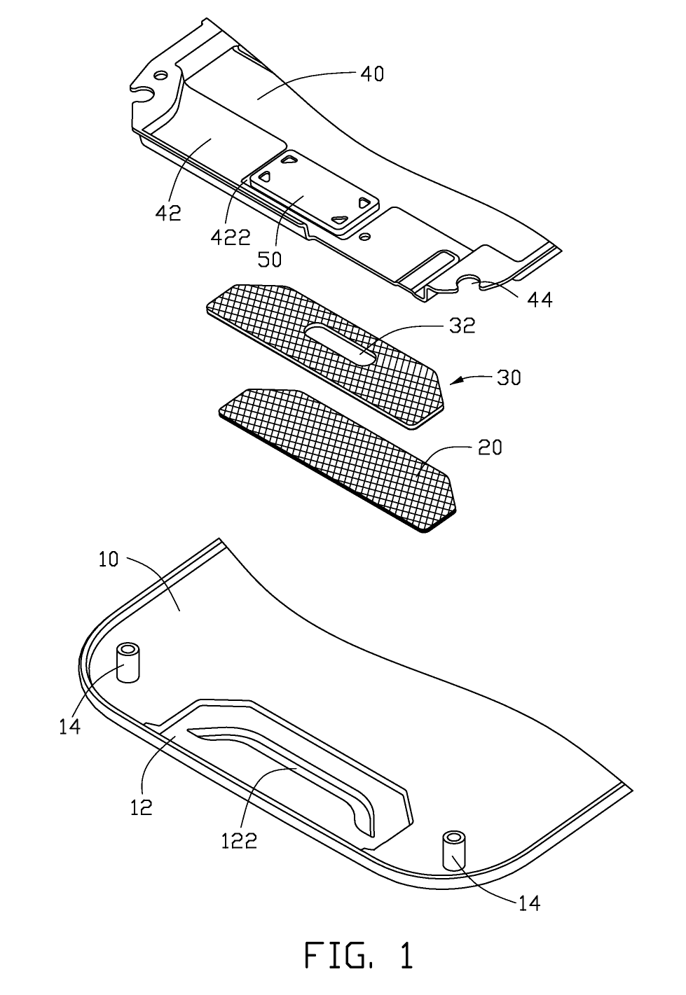

The exemplary embodiment of a receiving structure for a speaker as disclosed is suitable for an electronic device such as a mobile phone, portable computer, and other devices. Referring to FIG. 1, a receiving structure 100 includes a housing 10, a first filter 20, a second filter 30 structurally similar to the first filter 20, an engaging board 40, and a speaker 50 fixed to the engaging board 40.

The housing 10 defines a receiving cavity 12 in the interior surface adjacent to a distal end of the housing 10. The receiving cavity 12 receives the first filter 20 and the second filter 30. The bottom of the receiving cavity 12 includes a sound slot 122 allowing a transmission of the sound from the speaker 50. The housing 10 has two connecting poles 14 protruding from the interior surface and adjacent to the two opposite sides of the housing 10 for fixing the housing 10 to the engaging board 40.

The first and second filters 20, 30 are substantially the same shape and size and securely positioned in the receiving cavity 12. The first filter 20 prevents contaminants from entering the interior of the electronic device. The second filter 30 is the same color as the first filter 20 and defines sound apertures 32 at the center thereof.

The engaging board 40 includes a resisting wall 42 defining an assembly recess 422. The resisting wall 42 covers the receiving cavity 12. The assembly recess 422 receives part of the speaker 50. The bottom surface of the assembly recess 422 has an aperture (not shown) defined therein, the sound surface (not shown) of the speaker 50 attaches to the bottom surface of the assembly recess 422 after the speaker 50 assembled in the assembly recess 422. The engaging board 40 defines connecting holes 44 corresponding to the connecting poles 14 of the housing 10, so that, by engagement of the connecting poles 14 with the connecting holes 44, the engaging board 40 affixes securely to housing 10. The speaker 50 corresponds to the assembly recess 422 of the engaging board 40 and can be assembled therein. The sound from the speaker 50 passes through the aperture of the assembly recess 422 and enters the receiving cavity 12.

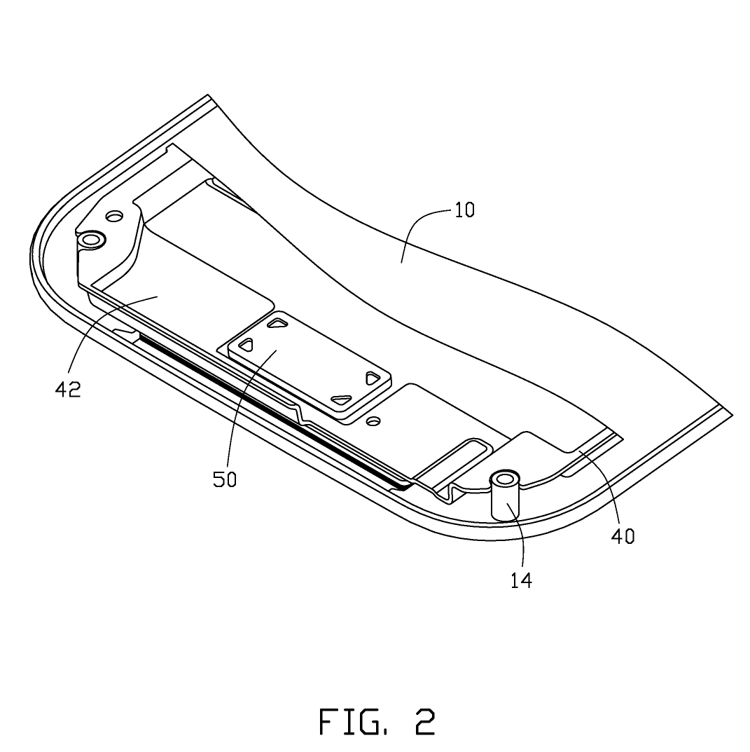

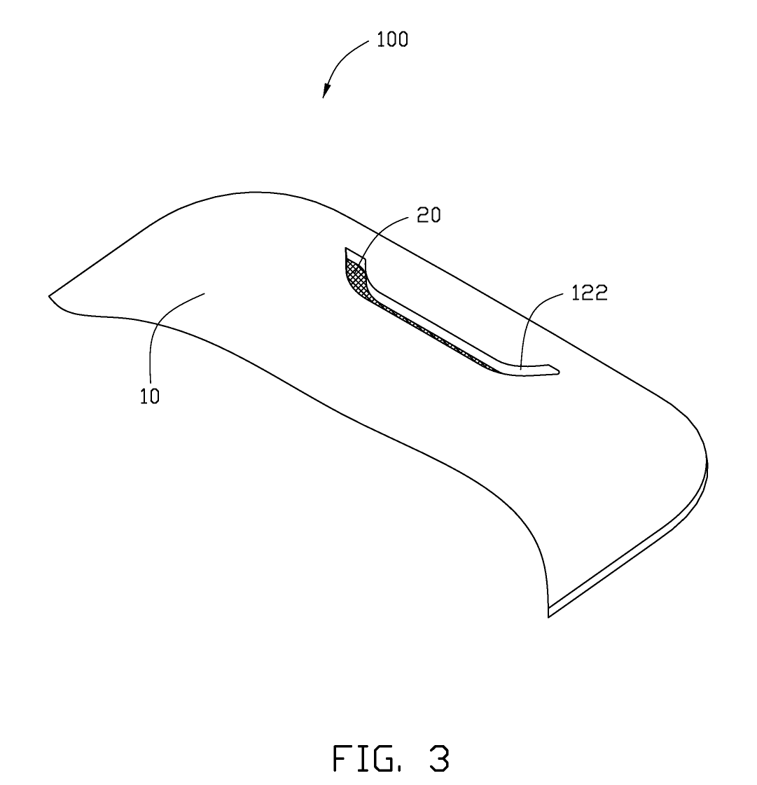

Referring further to FIGS. 2 and 3, in assembly of the receiving structure 100, the first filter 20 is received in the receiving cavity 12, shielding the sound slot 122. The second filter 30 is attached to the first filter 20 by, for example, an adhesive and the sound aperture 32 thereof aligns with the sound slot 122. The engaging board 40 combined with the speaker 50 is fixed to the housing 10, and the resisting wall 42 of the engaging board 40 covers the receiving cavity 12. The aperture of the bottom surface of the assembly recess 422 generally aligns with the sound aperture 32 of the second filter 30.

Because the sound slot 122 of the housing 10 is shielded by the first filter 20, contaminants are filtered from the outside. Moreover, the second filter 30 having the same color as the first filter 20 is stacked onto the first filter 20. Thus, the thickness of the filter combination is increased, and dust proofing is improved. Furthermore, the sound passes more easily by defining the sound aperture 32 of the second filter 30.

It is to be understood that the first filter 20 and the second filter 30 can be integrally formed as a whole.

It is to be understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A receiving structure for a speaker, comprising:
a housing comprising a receiving cavity defining a sound slot at the bottom thereof;
a first filter;
a second filter defining a sound aperture thereof; and
an engaging board fixed with a speaker;
wherein the first filter and the second filter are received in the receiving cavity and the sound slot is shielded by the first filter, the sound aperture aligns with the sound slot, the engaging board engages the housing and covers the receiving cavity, and the position of the speaker corresponds to the sound aperture.

2. The receiving structure as claimed in claim 1, wherein the first filter and the second filter are the same color.

3. The receiving structure as claimed in claim 1, wherein the housing forms connecting poles, with which connecting holes defined by the engaging board latch respectively.

4. The receiving structure as claimed in claim 1, wherein the second filter attaches to the first filter by adhesive.

5. The receiving structure as claimed in claim 1, wherein the engaging board includes a resisting wall covering the receiving cavity of the housing.

6. The receiving structure as claimed in claim 1, wherein the engaging board defines an assembly recess receiving the speaker.

7. A receiving structure for a speaker, comprising:
a housing comprising a receiving cavity defining a sound slot at the bottom thereof;
a filter defining a sound aperture without through out the filter; and
an engaging board integrally forming a speaker;
wherein the filter is received in the receiving cavity and the sound slot is shielded by the filter, the sound aperture aligns with the sound slot, the engaging board engages the housing and covers the receiving cavity, and the position of the speaker corresponds to the sound aperture.

8. The receiving structure as claimed in claim 7, wherein the housing forms connecting poles, with which connecting holes defined by the engaging board latch respectively.

9. The receiving structure as claimed in claim 7, wherein the filter includes a first filter and a second filter integrally formed with the first filter, in which the sound aperture is defined.
